(19) United States
(12) Patent Application Publication
(10) Pub. No.: US 2015/0189917 A1
(43) Pub. Date: Jul. 9, 2015

(54) CHARGING METHOD BASED ON AN ELECTRONIC CIGARETTE BOX AND CORRESPONDING ELECTRONIC CIGARETTE BOX

(71) Applicant: KIMREE HI-TECH INC., Tortola (VG)

(72) Inventor: Zhiyong Xiang, Huizhou City (CN)

(21) Appl. No.: 14/412,423

(22) PCT Filed: Apr. 27, 2013
(86) PCT No.: PCT/CN2013/074855

§ 371 Date: Dec. 31, 2014

(51) Int. Cl. A24F 47/00; A24F 15/00; H02J 7/00

(52) U.S. Cl. CPC A24F 47/008; H02J 7/007; A24F 15/00

(57) ABSTRACT

A charging method based on electronic cigarette box and a corresponding electronic cigarette box. The charging method based on electronic cigarette box includes: when there is a power to be charged being connected to the electronic cigarette box, detects the charging voltage of the power to be charged (101), then determines the power to be charged is linear charging mode or switch charging mode according to the charging voltage (102). If determines that the power to be charged is linear charging mode, then uses the voltage corresponding to the linear charging mode to charge the power to be charged (103). The method may improve the charge efficiency of the electronic cigarette box charging power of linear charging management mode such as charging on battery rod.

### FIELD OF THE INVENTION

The present invention relates to electronic cigarettes, especially relates to a charging method based on an electronic cigarette box and a corresponding electronic cigarette box.

### BACKGROUND OF THE INVENTION

The charging management method of an internal power of a current electronic cigarette is linear charging management, a voltage of constant voltage charging is 4.2V. The charging management method of an internal power of a mobile phone battery is switch charging management, the commonly used charging voltage is 5V. And current electronic cigarette boxes mainly use a same boost module to charge a battery rod and the mobile phone battery and so on, or use two boost modules to respectively charge the battery rod and mobile phone battery and so on.

Therefore, if the electronic cigarette box uses a same boost module to boost to 5V to charge battery rod or mobile phone, then when charging the battery rod, the voltage difference between the external charging voltage of the electronic cigarette box and the battery voltage of the battery rod is large, this part of the voltage difference is lost out by the linear charging mode, so the charging efficiency of the electronic cigarette box to the battery rod is very low by this charging mode.

But if using two or more boost modules to respectively use 4.3-4.4V (battery rod constant voltage charging voltage adding battery rod internal power charging voltage drop) and 5V voltage to respectively charge battery rod and mobile phone battery and so on, the cost is very high, it cannot meet consumers needs.

Therefore, the charge efficiency of the current electronic cigarette box with low cost charging power of linear charging management mode such as charging on battery rod is low, and the costs of those electronic cigarettes being able to improve the charge efficiency of charging power of linear charging management mode such as charging on battery rod are high, then all of them can not satisfy consumers needs.

### SUMMARY OF THE INVENTION

An embodiment of the present invention provides a charging method based on electronic cigarette box and a corresponding electronic cigarette box, which may improve the charge efficiency of the electronic cigarette box charging power of linear charging management mode such as charging on battery rod meanwhile reduces production costs, and better to meet the needs of consumers.

A first aspect of the present invention is to provide a charging method based on electronic cigarette box, including:

When there is a power to be charged being connected to the electronic cigarette box, detecting the charging voltage of the power to be charged.

Determining the power to be charged is linear charging mode or switch charging mode according to the charging voltage.

If determines that the power to be charged is linear charging mode, then using the voltage corresponding to the linear charging mode to charge the power to be charged.

Furthermore, after determining the power to be charged is linear charging mode or switch charging mode according to the charging voltage, the method further includes:

If determines that the power to be charged is switch charging mode, then using the voltage corresponding to the switch charging mode to charge the power to be charged.

Furthermore, the step of determining the power to be charged is linear charging mode or switch charging mode according to the charging voltage is specified:

If detects that the power to charged is 4.2V constant voltage charging, then the power to charged is linear charging mode.

If detects that the power to charged is 5V voltage charging, then the power to charged is switch charging mode.

Furthermore, the step of using the voltage corresponding to the linear charging mode to charge the power to be charged is specified that:

Outputs 4.3V-4.4V voltage to charge the battery rod of the electronic cigarette.

Furthermore, the step of using the voltage corresponding to the switch charging mode to charge the power to be charged is specified that:

Outputs 5V voltage to charge the mobile phone battery.

The present invention further provides an electronic cigarette box corresponding to the aforementioned invention. The electronic cigarette box includes:

A charging voltage detection module of a power to be charged, being used to detect the charging voltage of the power to be charged when there is a power to be charged being connected to the electronic cigarette box, and output to a microprocessor.

A microprocessor, being used to receive the detection result sent by the charging voltage detection module of the power to be charged, then determines the power to be charged is linear charging mode or switch charging mode according to the detection result, and outputs linear charging mode control signal or switch charging mode control signal to a boost module according to the detection result.

A boost module, being used to receive the linear charging mode control signal sent by the microprocessor, and uses the voltage corresponding to the linear charging mode to charge the power to be charged according to the received linear charging mode control signal.

Furthermore, the charging voltage detection module of the power to be charged includes a first resistor and a second resistor which are connected in series; the other end of the first resistor is connected with the power to be charged, and the other end of the second resistor is grounded.

Furthermore, the boost module includes a PWM transformer.

Furthermore, the boost module is further used to receive the switch charging mode control signal sent by the microprocessor, and uses the voltage corresponding to the switch charging mode to charge the power to be charged according to the received switch charging mode control signal.

The aforementioned description shows that, in the present invention, when there is a power to be charged being connected to the electronic cigarette box, detects the charging voltage of the power to be charged, then determines the power to be charged is linear charging mode or switch charging mode according to the charging voltage. If determines that the power to be charged is linear charging mode, then uses the voltage corresponding to the linear charging mode to charge the power to be charged. The method may improve the charge efficiency of the electronic cigarette box charging on battery rod and other power of linear charging management mode, meanwhile reduces production costs, and better to meet the needs of consumers.

### BRIEF DESCRIPTION OF THE DRAWINGS

In order to be more clearly describe the technical solutions of the present invention, the drawings of the embodiments will be described in the following. Obviously, the following described drawings are only some embodiments of the present invention; one skilled in the art may obtain other drawings according to these drawings without departing from the true spirit and scope of the disclosure.

FIG. 1 is a flow chart of a charging method based on electronic cigarette box according to an embodiment of the present invention.

FIG. 2 is a logical schematic diagram of an electronic cigarette box according to the embodiment of the present invention.

FIG. 3 is a logical schematic diagram of a part of an electronic cigarette box according to the embodiment of the present invention.

### DETAILED DESCRIPTION OF THE INVENTION

The present invention will be clearly and completely described in detail in the following combining figures and embodiments. Obviously, the described embodiments are part of the embodiments of the present invention, but not all embodiments. Various improvement and modifications can be made to the embodiments by those skilled in the art without departing from the true spirit and scope of the disclosure. The scope of the present invention is defined by the appended claims and equivalents thereof.

An embodiment of the present invention provides a charging method based on an electronic cigarette box and a corresponding electronic cigarette box, which may improve the charge efficiency of the electronic cigarette box charging power of linear charging management mode such as charging on battery rod, meanwhile reduces production costs, and better to meet the needs of consumers. Following will describe in detail.

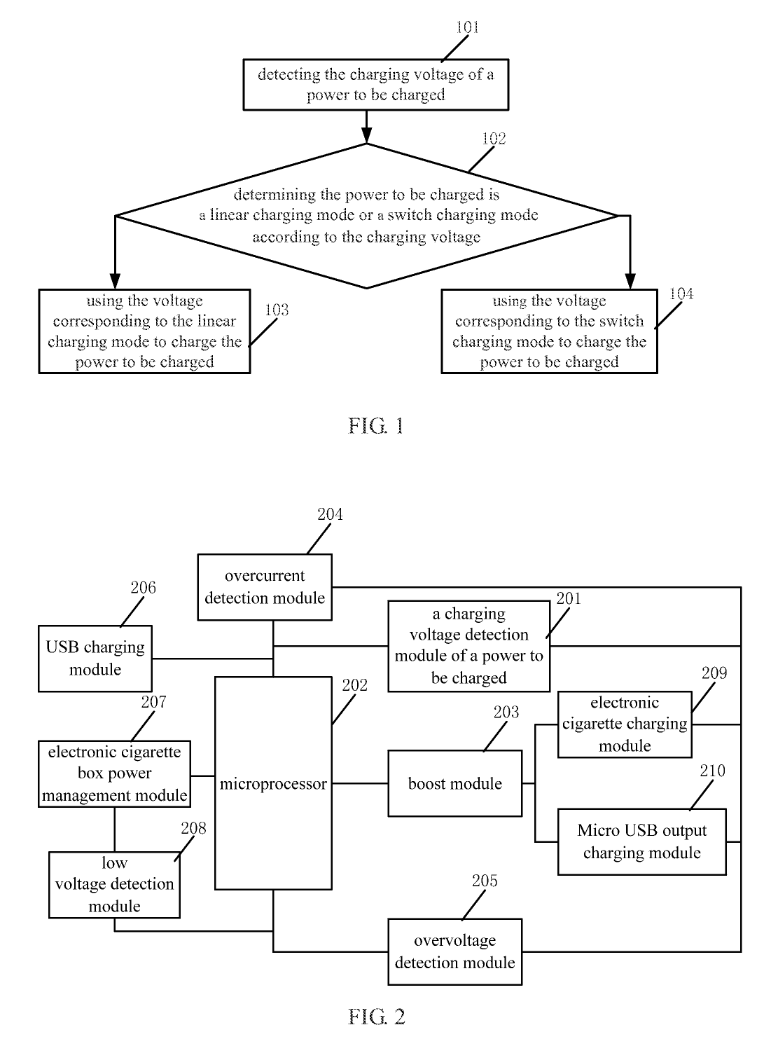

Referring to FIG. 1, FIG. 1 is a flow chart of a charging method based on electronic cigarette box according to the embodiment of the present invention. As shown in FIG. 1, the method may include the following steps.

101, detects the charging voltage of a power to be charged.

When the electronic cigarette box detects that there is a power to be charged being connected to the electronic cigarette box, detecting the charging voltage of the power to be charged. Specifically, when the charging management module of the power to be charged detects that the voltage output from the electronic cigarette box is the charging voltage needed, then the charging starts, at this time the electronic cigarette box obtains the charging voltage of the power to be charged.

102, determining the power to be charged is a linear charging mode or a switch charging mode according to the charging voltage.

After detecting the charging voltage of the power to be charged which is connected to the electronic cigarette box, then determining the power to be charged is linear charging mode or switch charging mode according to the charging voltage. Specifically, for example:

If detecting that the power to charged is 4.2V constant voltage charging, then the power to charged is linear charging mode; if detects that the power to charged is 5V voltage charging, then the power to charged is switch charging mode.

103, uses the voltage corresponding to the linear charging mode to charge the power to be charged.

If in step 102 determining that the power to be charged is linear charging mode, then uses the voltage corresponding to the linear charging mode to charge the power to be charged. Specifically, for example outputs 4.3V-4.4V voltage to charge the battery rod of the electronic cigarette.

104, uses the voltage corresponding to switch charging mode to charge the power to be charged.

If in the step 102 determining that the power to be charged is switch charging mode, then uses the voltage corresponding to the switch charging mode to charge the power to be charged. Specifically, for example outputs 5V voltage to charge the mobile phone battery and so on.

In the embodiment, when there is a power to be charged being connected to the electronic cigarette box, detects the charging voltage of the power to be charged, that is when the charging management module of the power to be charged detects that the voltage outputting from the electronic cigarette box is the charging voltage needed, then the charging starts, at this time the electronic cigarette box obtains the charging voltage of the power to be charged; then determines the power to be charged is linear charging mode or switch charging mode according to the charging voltage. If determines that the power to be charged is linear charging mode, then uses the voltage corresponding to the linear charging mode to charge the power to be charged. The method may improve the charge efficiency of the electronic cigarette box charging power of linear charging management mode such as charging on battery rod, meanwhile reduces production costs, and better to meet the needs of consumers.

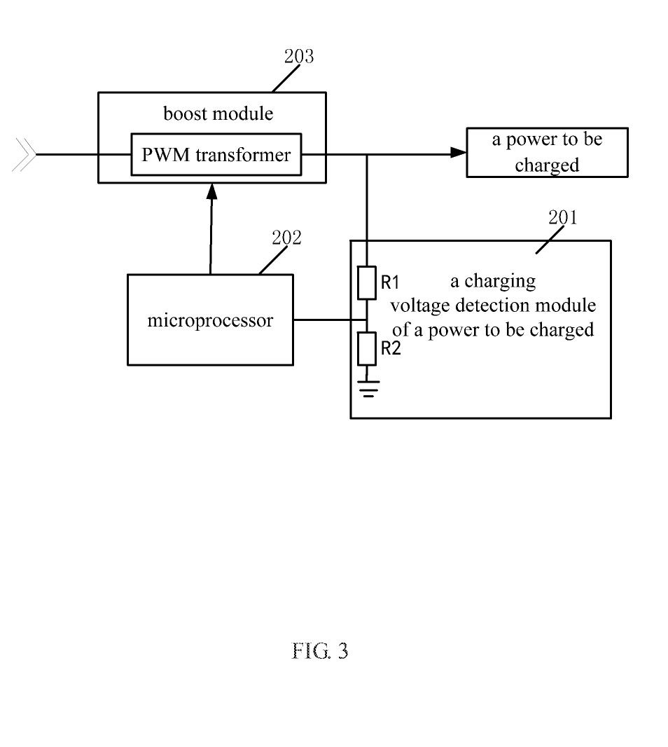

Referring to FIG. 2, FIG. 2 is a logical schematic diagram of an electronic cigarette box according to the embodiment of the present invention.

Referring to FIG. 2, the electronic cigarette box includes a charging voltage detection module 201 of a power to be charged, a microprocessor 202, a boost module 203, a overcurrent detection module 204, a overvoltage detection module 205, a USB charging module 206, an electronic cigarette box power management module 207, a low voltage detection module 208, an electronic cigarette charging module 209 and a Micro USB output charging module 210.

Wherein, one end of the charging voltage detection module 201 of a power to be charged, the boost module 203, the overcurrent detection module 204, the overvoltage detection module 205, the USB charging module 206, the electronic cigarette box power management module 207 and the low voltage detection module 208 each is respectively connected with the microprocessor 202; the other end of the charging voltage detection module 201 of a power to be charged, the boost module 203, the overcurrent detection module 204 and the overvoltage detection module 205 each is respectively connected with the electronic cigarette charging module 209 and the Micro USB output charging module 210; the other end of the low voltage detection module 208 is connected with the electronic cigarette box power management module 207.

The charging voltage detection module 201 of a power to be charged is used to detect the charging voltage of the power to be charged when there is a power to be charged being connected to the electronic cigarette box, and outputs to the microprocessor 202. Detecting the charging voltage of the power to be charged, specifically, when the charging management module of a power to be charged detects that the voltage output from the electronic cigarette box is the charging voltage needed, then the charging starts, at this time the electronic cigarette box obtains the charging voltage of the power to be charged.

The microprocessor 202 is used to receive the detection result sent by the charging voltage detection module 201 of a power to be charged, then determines the power to be charged is linear charging mode or switch charging mode according to the detection result, and outputs linear charging mode control signal or switch charging mode control signal to the boost module 203 according to the detection result.

The boost module 203 is used to receive the linear charging mode control signal sent by the microprocessor 202, and uses the voltage corresponding to the linear charging mode to charge the power to be charged according to the received linear charging mode control signal.

Specifically, referring to FIG. 3, The charging voltage detection module 201 of a power to be charged includes a resistor R1 and a resistor R2 which are connected in series, wherein the other end of the resistor R2 is grounded, and the other end of the resistor R1 is connected with the power to be charged. The charging voltage detection module 201 of a power to be charged achieves the detection of the voltage of the power to be charged by voltage dividing mode of dividing resistor. The boost module 203 includes a PWM transformer. After the charging voltage detection module 201 of a power to be charged detecting the charging voltage of the power to be charged, the microprocessor 202 sends corresponding pulse signal to the boost module 203 according to different detection results, the boost module 203 achieves the control on the output voltage of the boost module 203 by adjusting the output frequency of the pulse wave, then achieves to use different charging voltage for the power to be charged of different charging mode.

Furthermore, the boost module 203 is further used to receive the switch charging mode control signal sent by the microprocessor 202, and uses the voltage corresponding to the switch charging mode to charge the power to be charged according to the received switch charging mode control signal.

Furthermore, the electronic cigarette box of the embodiment further includes the overcurrent detection module 204 operable to overcurrent detect, and the overvoltage detection module 205 operable to overvoltage detect.

Furthermore, the electronic cigarette box of the embodiment further includes the USB charging module 206 for charging the electronic cigarette box by USB.

Furthermore, the electronic cigarette box of the embodiment further includes the electronic cigarette box power management module 207 operable to manage power, and the low voltage detection module 208 operable to detect low voltage.

Furthermore, the electronic cigarette box of the embodiment further includes the electronic cigarette charging module 209 operable to charge the electronic cigarette of linear charging mode, and the Micro USB output charging module 210 operable to charge mobile phone power of switch charging module and so on.

In the embodiment, the electronic cigarette box detects the charging voltage of the power to be charged by the charging voltage detection module of a power to be charged, that is when the charging management module of a power to be charged detects that the voltage output from the electronic cigarette box is the charging voltage needed, then the charging starts, at this time the charging voltage detection module of the electronic cigarette box obtains the charging voltage of the power to be charged; the microprocessor determines the power to be charged is linear charging mode or switch charging mode according to the voltage detected by the charging voltage detection module of a power to be charged. When the microprocessor determines that the power to be charged is linear charging mode, the microprocessor controls the boost module to use the voltage corresponding to the linear charging mode to charge the power to be charged. The method may improve the charge efficiency of the electronic cigarette box charging power of linear charging management mode such as charging on battery rod, and uses a same boost module to charge battery rod and mobile phone battery by different output voltage, reduces production costs, and better to meet the needs of consumers.

The charging method based on an electronic cigarette box and the corresponding electronic cigarette box of the present invention are described in detail as aforementioned. The charging method based on electronic cigarette boxes and the corresponding electronic cigarette box of the present invention have the following several advantages.

Firstly, in the present invention, when there is a power to be charged being connected to the electronic cigarette box, detects the charging voltage of the power to be charged, then determines the power to be charged is linear charging mode or switch charging mode according to the charging voltage. If determines that the power to be charged is linear charging mode, then uses the voltage corresponding to the linear charging mode to charge the power to be charged. The method may improve the charge efficiency of the electronic cigarette box charging power of linear charging management mode such as charging on battery rod.

Secondly, the present invention uses a boost module to charge the battery rod of the electronic cigarette and mobile phone battery by different output voltage, reduces production costs, and better to meet the needs of consumers.

For those skilled in the art, it is understood that the all or part of steps in the various methods of the aforementioned embodiments may be completed by a program instructing relevant hardware. The program may be stored in a readable storage media of a computer. The storage media may be flash disk, Read-Only Memory (ROM), Random Access Memory (RAM), disk or CD-ROM and so on.

A charging method based on an electronic cigarette box and the corresponding electronic cigarette box of the embodiment of the present invention are described in detail as aforementioned. In the article, the principle and embodiments of the present invention have been described by specific embodiments. The description of the aforementioned embodiments is only used to help understanding the methods and the core idea of the present invention. Meanwhile, various improvement and modifications can be made to the embodiments by those skilled in the art without departing from the true spirit and scope of the present invention. In summary, contents of this document should not be construed as limiting the present invention.

What is claimed is:

1. A charging method based on an electronic cigarette box, comprising:
when there is a power to be charged being connected to the electronic cigarette box, detecting the charging voltage of the power to be charged;
determining the power to be charged is a linear charging mode or a switch charging mode according to the charging voltage;
if determines that the power to be charged is the linear charging mode, then using the voltage corresponding to the linear charging mode to charge the power to be charged.

2. According to the method in claim 1, wherein after determining the power to be charged is a linear charging mode or a switch charging mode according to the charging voltage, the method further comprises:
if determines that the power to be charged is the switch charging mode, then using the voltage corresponding to the switch charging mode to charge the power to be charged.

3. According to the method in claim 2, wherein the step of determining the power to be charged is a linear charging mode or a switch charging mode according to the charging voltage is specified that:
if detects that the power to charged is 4.2V constant voltage charging, then the power to charged is linear charging mode; and
if detects that the power to charged is 5V voltage charging, then the power to charged is switch charging mode.

4. According to the method in any of claim 1 to claim 3, wherein the step of using the voltage corresponding to the linear charging mode to charge the power to be charged is specified that: outputting 4.3V-4.4V voltage to charge a battery rod of the electronic cigarette.

5. According to the method in any of claim 2 to claim 3, wherein the step of using the voltage corresponding to the switch charging mode to charge the power to be charged is specified that: outputting 5V voltage to charge a mobile phone battery.

6. An electronic cigarette box, comprising:
a charging voltage detection module of a power to be charged, being used to detect the charging voltage of the power to be charged when there is a power to be charged being connected to the electronic cigarette box, and to output to a microprocessor;
the microprocessor, being used to receive the detection result sent by the charging voltage detection module of a power to be charged, then to determine the power to be charged is a linear charging mode or a switch charging mode according to the detection result, and to output linear charging mode control signal or switch charging mode control signal to a boost module according to the detection result; and
the boost module, being used to receive the linear charging mode control signal sent by the microprocessor, and to use the voltage corresponding to the linear charging mode to charge the power to be charged according to the received linear charging mode control signal.

7. According to the electronic cigarette box in claim 6, wherein the boost module is further used to receive a switch charging mode control signal sent by the microprocessor, and uses the voltage corresponding to the switch charging mode to charge the power to be charged according to the received switch charging mode control signal.

8. According to the electronic cigarette box in claim 6 or claim 7, wherein the charging voltage detection module of a power to be charged includes a first resistor and a second resistor which are connected in series; the other end of the first resistor is connected with the power to be charged, and the other end of the second resistor is grounded.

9. According to the electronic cigarette box in claim 8, wherein the boost module comprises a PWM transformer.
